(19) United States
(12) Patent Application Publication
(10) Pub. No.: US 2011/0258481 A1
(43) Pub. Date: Oct. 20, 2011

(54) Deploying A Virtual Machine For Disaster Recovery In A Cloud Computing Environment

(75) Inventor: Eric R. Kern, Chapel Hill, NC (US)

(73) Assignee: INTERNATIONAL BUSINESS MACHINES CORPORATION, Armonk, NY (US)

(21) Appl. No.: 12/759,976

(22) Filed: Apr. 14, 2010

(51) Int. Cl. G06F 11/20

(52) U.S. Cl. 714/4.1; 714/E11.073

(57) ABSTRACT

Deploying a virtual machine in a cloud computing environment, the cloud computing environment including one or more virtual machines (‘VMs’), the VMs being modules of automated computing machinery installed upon cloud computers disposed within data centers, the cloud computing environment also including a cloud operating system and data center administration servers operably coupled to the VMs, including deploying, by the cloud operating system in a local data center, a VM, including flagging the VM for disaster recovery; storing, by the cloud operating system in computer memory in a remote data center, a copy of the flagged VM; and configuring, by the cloud operating system, the remote data center to replace data processing operations of the flagged VM in the local data center with data processing operations of the copy in the remote data center when the flagged VM in the local data center is lost through disaster.

### BACKGROUND OF THE INVENTION

1. Field of the Invention

The field of the invention is data processing, or, more specifically, methods, apparatus, and products for deploying a virtual machine for disaster recovery in a cloud computing environment.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas of technology that has seen recent advancement is cloud computing. Cloud computing is increasingly recognized as a cost effective means of delivering information technology services through a virtual platform rather than hosting and operating the resources locally. Modern clouds with hundred or thousands of blade servers enable system administrators to build highly customized virtual machines to meet a huge variety of end user requirements. Many virtual machines, however, can reside on a single powerful blade server. Cloud computing has enabled customers to build virtualized servers on hardware over which they have absolutely no control. Deploying an application in a cloud computing environment simplifies the overall solution because the hardware becomes abstracted behind the cloud infrastructure. The end user, however, loses all control over the underlying hardware infrastructure including particularly loss of control over the ability to enable disaster recovery.

### SUMMARY OF THE INVENTION

Methods, apparatus, and computer program products for deploying a virtual machine in a cloud computing environment, the cloud computing environment including one or more virtual machines (‘VMs’), the VMs being modules of automated computing machinery installed upon cloud computers disposed within data centers, the cloud computing environment also including a cloud operating system and data center administration servers operably coupled to the VMs, including deploying, by the cloud operating system in a local data center, a VM, including flagging the VM for disaster recovery; storing, by the cloud operating system in computer memory in a remote data center, a copy of the flagged VM; and configuring, by the cloud operating system, the remote data center to replace data processing operations of the flagged VM in the local data center with data processing operations of the copy in the remote data center when the flagged VM in the local data center is lost through disaster.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIGS. 1 and 2 set forth functional block diagrams of apparatus that deploys a virtual machine for disaster recovery in a cloud computing environment according to embodiments of the present invention.

FIGS. 3-6 set forth flowcharts illustrating example methods of deploying a virtual machine for disaster recovery in a cloud computing environment according to embodiments of the present invention.

### DETAILED DESCRIPTION OF EXEMPLARY EMBODIMENTS

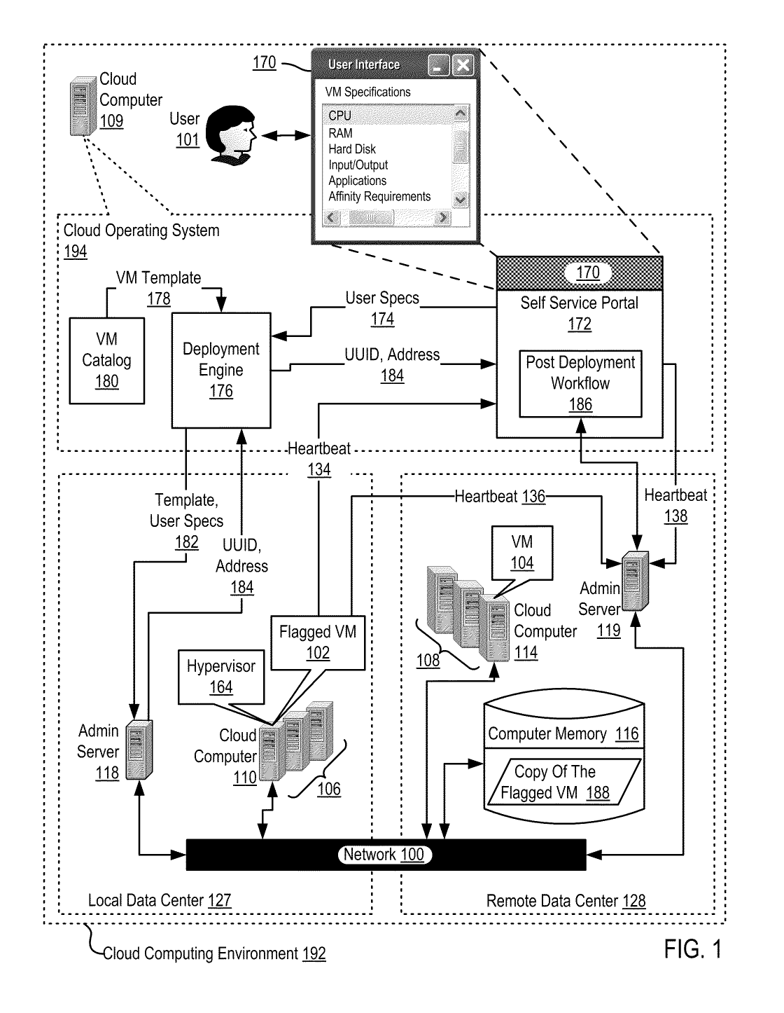

Example methods, apparatus, and products for deploying a virtual machine for disaster recovery in a cloud computing environment according to embodiments of the present invention are described with reference to the accompanying drawings, beginning with FIG. 1. FIG. 1 sets forth a functional block diagram of apparatus that deploys a virtual machine for disaster recovery in a cloud computing environment according to embodiments of the present invention. The apparatus in the example of FIG. 1 implements a cloud computing environment (192) that includes a virtual machine (‘VM’) (102) to be deployed for disaster recovery, where the VM is modules of automated computing machinery installed upon a cloud computer (110) disposed within a local data center (127). The local data center is said to be ‘local’ with respect to the subject VM. That is, the ‘local’ data center (127) is the data center in which the VM is deployed for disaster recovery. The apparatus in the example of FIG. 1 also includes a remote data center (128), a data center that is physically separate from the local data center—so that it can be used for recovery from loss of the local data center, or VMs in the local data center—through disaster.

The cloud computing environment (192) is a network-based, distributed data processing system that provides one or more cloud computing services. Although shown here, for convenience of explanation, with only a few computers (106, 108, 109, 118, 119) in the cloud computing environment, such a cloud computing environment typically includes, as a practical matter, many computers, hundreds or thousands of them, disposed within data centers, with the computers typically implemented in the blade form factor. Typical examples of cloud computing services include Software as a Service (‘SaaS’) and Platform as a Service (‘PaaS’). SaaS is a model of software deployment in which a provider licenses an application to customers for use as a service on demand. SaaS software vendors may host the application on their own clouds or download such applications from clouds to cloud clients, disabling the applications after use or after an on-demand contract expires.

PaaS is the delivery from a cloud computing environment of a computing platform and solution stack as a service. PaaS includes the provision of a software development platform designed for cloud computing at the top of a cloud stack. PaaS also includes workflow facilities for application design, application development, testing, deployment and hosting as well as application services such as team collaboration, web service integration and marshalling, database integration, security, scalability, storage, persistence, state management, application versioning, application instrumentation and developer community facilitation. These services are provisioned as an integrated solution over a network, typically the World Wide Web (‘web’) from a cloud computing environment. Taken together, SaaS and PaaS are sometimes referred to as ‘cloudware.’

In addition to SaaS and PaaS, cloud computing services can include many other network-based services, such as, for example, utility computing, managed services, and web services. Utility computing is the practice of charging for cloud services like utilities, by units of time, work, or resources provided. A cloud utility provider can, for example, charge cloud clients for providing for a period of time certain quantities of memory, I/O support in units of bytes transferred, or CPU functions in units of CPU clock cycles utilized.

Managed services implement the transfer of all management responsibility as a strategic method for improving data processing operations of a cloud client, person or organization. The person or organization that owns or has direct oversight of the organization or system being managed is referred to as the offerer, client, or customer. The person or organization that accepts and provides the managed service from a cloud computing environment is regarded as a managed service provider or ‘MSP.’ Web services are software systems designed to support interoperable machine-to-machine interaction over a network of a cloud computing environment.

Web services provide interfaces described in a machine-processable format, typically the Web Services Description Language (‘WSDL’). Cloud clients interact with web services of a cloud computing environment as prescribed by WSDL descriptions using Simple Object Access Protocol (‘SOAP’) messages, typically conveyed using the HyperText Transport Protocol (‘HTTP’) with an eXtensible Markup Language (‘XML’) serialization.

The data centers (127, 128) are facilities used for housing a large amount of electronic equipment, particularly computers and communications equipment. Such data centers are maintained by organizations for the purpose of handling the data necessary for its operations. A bank, for example, may have data centers where all its customers' account information is maintained and transactions involving the accounts are carried out. Practically every company that is mid-sized or larger has at least one data center with the larger companies often having dozens of data centers. A cloud computing environment implemented with cloud computers in data centers will typically include many computers, although for ease of explanation, the cloud computing environment (129) in the example of FIG. 1 is shown with only a few (106, 108, 109, 118, 119). The apparatus in the example of FIG. 1 includes data center administration servers (118, 119), a cloud computer (109) running a cloud operating system (194), several additional cloud computers (106, 108), and a data communications network (100) that couples the computers of the cloud computing environment (192) for data communications.

A ‘computer’ or ‘cloud computer,’ as the terms are used in this specification, refers generally to a multi-user computer that provides a service (e.g. database access, file transfer, remote access) or resources (e.g. file space) over a network connection. The terms ‘computer’ or ‘cloud computer’ as context requires, refer inclusively to the each computer's hardware as well as any application software, operating system software, or virtual machine installed or operating on the computer. A computer application in this context, that is, in a data center or a cloud computing environment, is often an application program that accepts connections through a computer network in order to service requests from users by sending back responses. The form factor of data center computers is often a blade; such computers are often referred to as ‘blade servers.’ Examples of application programs, often referred to simply as ‘applications,’ include file servers, database servers, backup servers, print servers, mail servers, web servers, FTP servers, application servers, VPN servers, DHCP servers, DNS servers, WINS servers, logon servers, security servers, domain controllers, backup domain controllers, proxy servers, firewalls, and so on.

The data center administration servers (118, 119) are computers that are operably coupled to VMs in the cloud computing environment through data communications network (100). Each data center administration server (118, 119) provides the data center-level functions of communicating with hypervisors on cloud computers to install VMs, terminate VMs, and move VMs from one cloud computer to another within the data center. In addition, data center administration servers (in some embodiments support an additional module called a VM Manager that implements direct communications with VMs through modules called VM agents installed in the VMs themselves.

The example apparatus of FIG. 1 includes a cloud operating system (194) implemented as a module of automated computing machinery installed and operating on one of the cloud computers (109). The cloud operating system is in turn composed of several submodules: a virtual machine catalog (180), a deployment engine (176), and a self service portal (172). The self service portal is so-called because it enables users (101) themselves to set up VMs as they wish, although users specifying VMs through the self service portal typically have no knowledge whatsoever of the actual underlying computer hardware in the cloud computing environment—and no knowledge whatsoever regarding how their VMs are disposed upon the underlying hardware. Any particular VM can be installed on a cloud computer with many other VMs, all completely isolated from one another in operation. And all such VMs, from the perspective of any operating system or application running on a VM, can have completely different configurations of computer resources, CPUs, memory, I/O resources, and so on. Examples of cloud operating systems that can be adapted for use in deploying a virtual machine for disaster recovery in a cloud computing environment according to embodiments of the present invention include VMware's Cloud OS™, the open-source eyeOS™ from eyeOS Forums, Xcerions' iCloud™, Microsoft's Windows Live Core™, Google's Chrome™, and gOS™ from Good OS.

In the example cloud operating system of FIG. 1, the self service portal (172) exposes user interface (170) for access by any user (101) that is authorized to install VMs in the cloud computing environment (192). The user may be an enterprise Information Technology (‘IT’) professional, an IT manager or IT administrator, setting up VMs to run applications to be used by dozens, hundreds, or thousands of enterprise employees. Or the user (101) may be an individual subscriber to cloud computing services provided through or from the cloud computing environment. The self service portal (172) receives through the user interface (170) user specifications (174) of VMs. The user specifications include for each VM specifications of computer resources to be provided as the VM, types and numbers of computer processors, quantity of random access memory, hard disk storage, input/output resources, application programs, requirements for disaster recovery, and so on. The specifications can also include requirements for I/O response timing, memory bus speeds, Service Level Agreements (‘SLAs’), Quality Of Service (‘QOS’) requirements, and other VM specifications as may occur to those of skill in the art.

Having received user specifications for a VM, the cloud operating system (194) then deploys the now-specified VM in accordance with the received user specifications. The self service portal (172) passes the user specification (174) to the deployment engine (176). The self service portal retains any disaster recovery requirements supplied by the user in storage for use after deployment. The VM catalog (180) contains VM templates, standard-form descriptions used by hypervisors to define and install VMs. The deployment engine (176) selects a VM template (178) that matches the user specifications. If the user specified an Intel processor, the deployment engine selects a VM template for a VM that executes applications on an Intel processor. If the user specified PCIe I/O functionality, the deployment engine selects a VM template for a VM that provides PCIe bus access. And so on. The deployment engine fills in the selected template with the user specifications and passes the complete template (182) to the data center administration server (118) in the local data center (127). The data center administration server (118) then calls a hypervisor (164) on a cloud computer (110) to install the VM specified by the selected, completed VM template. The data center administration server (118) records a network address assigned to the new VM as well as a unique identifier for the new VM, here represented by a UUID, and returns the network address and the UUID (184) to the deployment engine (176). The deployment engine (176) returns the network address and the UUID (184) to the self service portal (172).

The subject VM (102) in this example has a disaster recovery requirement provided as part of its user specifications (174). Such a disaster recovery requirement is specified by the user (101) through interface (170) and retained by the self service portal as part of the specification of a VM being installed in the cloud computer environment (192), thus ‘flagging’ the VM for disaster recovery in the records maintained by the self service portal. The term ‘disaster recovery’ is used here to refer to methods and apparatus that recover data processing services of VMs after a loss through disaster. A disaster can be natural or man made, including anything that can interfere with or destroy the ability of a VM to run in a data center, including damage very locally to a single computer or loss of an entire data center from flood, fire, earthquake, hurricane, accidents, labor walkouts or strikes, sabotage, burglary, virus, intrusion, and so on. Disaster recovery supports high availability, where the recovery is for a single VM running as one of a hundred VMs in a cluster and the loss merely degrades data processing performance momentarily, as well as recovery from total loss of an entire data center including total loss of an entire application spread across a thousand blade servers in a cluster. In the example of FIG. 1, both of the data centers (127, 128) are illustrated, for ease of explanation, with only one VM respectively (102, 104). Readers will recognize, however, that as a practical matter, such data centers typically contain many VMs, hundreds or thousands, some flagged for disaster recovery, some not.

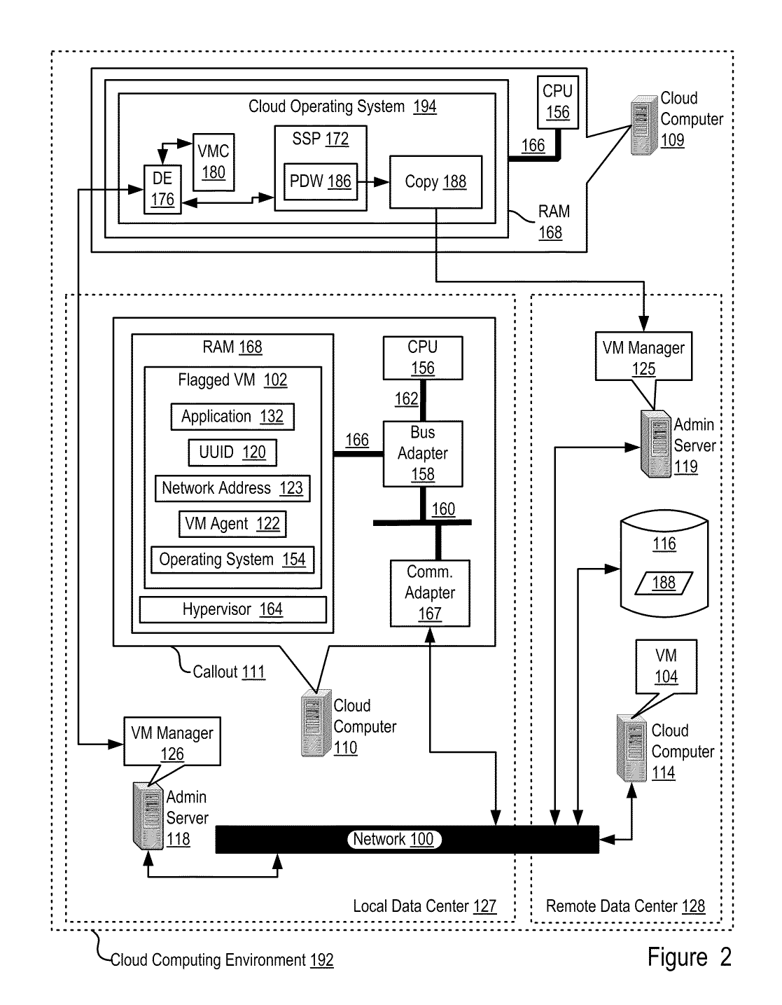

When, as here, there is a disaster recovery requirement, the self service portal (172) module of the cloud operating system (194) stores in computer memory (116) in a remote data center (128), a copy (188) of the flagged VM (102). The self service portal (172) possesses data communications addresses, port numbers, and security permissions to enable it to store the copy in memory (116) in the remote data center (128). In apparatus like that of FIG. 2, a copy of a VM can be fully characterized, at any point in time during operation of the VM, by a completed template for the VM including user specifications and the contents of computer memory, including the contents of a CPU's architectural registers that are in use by the VM, the contents of RAM in use by the VM, and the contents of any hard disk space in use by the VM. In an embodiment, the computer memory (116) in the remote data center (128) is implemented as a Storage Area Network or ‘SAN’ whose memory is accessible remotely by the self service portal (172) in the form of Logical Unit Numbers or ‘LUNs.’ In some embodiments, the cloud operating system stores the copy not merely once but periodically with, for example, a periodicity specified by the user in the user specifications (174) for the VM (102). For a VM having no need for high availability, the cloud operating system may store the VM hourly or daily, for example. For others, the periodicity may be a small fraction of a second. In some embodiments, each store is a store of an entire copy of the VM. In others, the initial store is a full copy and periodic additional stores are incremental.

The self service module of the cloud operating system also configures the remote data center (128) to replace data processing operations of the flagged VM (102) in the local data center with data processing operations of the copy (188) in the remote data center when the flagged VM in the local data center is lost through disaster. Such configuring is carried out in an embodiment by advising the data center administration server (119) in the remote data center (128) of the need for disaster recovery service for the VM (102), of the fact that the copy (188) is now stored in computer memory (116) in the remote data center (128), and of the location in computer memory where the copy is stored, information which the data center administration server (119) in the remote data center (128) maintains in its computer memory. In some embodiments, the form of disaster recovery service actually provided by the remote data center can be a simple as returning the copy (188) to the local data center (127) as part of a disaster recovery plan for the local data center. In other embodiments, the cloud operating system (194, 172) configures the remote data center (128), that is, so advises the data center administration server (119) in the remote data center (128), to recover the copy (188) from computer memory (116) and deploy the copy as a VM (104) in the remote data center (128).

The arrangement of the servers (118, 119), the cloud computers (106, 108, 109), and the network (100) making up the example apparatus illustrated in FIG. 1 are for explanation, not for limitation. Data processing systems useful for deploying a virtual machine for disaster recovery in a cloud computing environment according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

For further explanation, FIG. 2 sets forth a functional block diagram of apparatus that deploys a virtual machine for disaster recovery in a cloud computing environment (192) according to embodiments of the present invention. Deploying a virtual machine for disaster recovery in a cloud computing environment in accordance with the present invention is implemented generally with computers, that is, with automated computing machinery. Among the example apparatus of FIG. 2, the data center administration servers (118, 119), the cloud computers (110, 114, 109), and the network (100) are all implemented as or with automated computing machinery. For further explanation, FIG. 2 sets forth in a callout (111) a block diagram of some of the components of automated computing machinery comprised within cloud computer (110) that are used to deploy a virtual machine for disaster recovery in a cloud computing environment according to embodiments of the present invention. The cloud computer (110) of FIG. 2 includes at least one computer processor (156) or ‘CPU’ as well as random access memory (‘RAM’) (168) which is connected through a high speed memory bus (166) and bus adapter (158) to CPU (156) and to other components of the cloud computer (110). The example cloud computer (110) of FIG. 2 includes a communications adapter (167) for data communications with other computers through data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for deploying a virtual machine for disaster recovery in a cloud computing environment according to embodiments of the present invention include modems for wired dial-up communications, Ethernet (IEEE 802.3) adapters for wired data communications network communications, and 802.11 adapters for wireless data communications network communications.

Stored in RAM (168) in the example cloud computer (110) of FIG. 2 is a hypervisor (164). The hypervisor (164) is a mechanism of platform-virtualization, a module of automated computing machinery that supports multiple operating systems running concurrently in separate virtual machines on the same host computer. The hypervisor (164) in this example is a native or bare-metal hypervisor that is installed directly upon the host computer's hardware to control the hardware and to monitor guest operating systems (154) that execute in virtual machines. Each guest operating system runs on a VM (102) that represents another system level above the hypervisor (164) on cloud computer (110). Examples of hypervisors useful or that can be improved for use in deploying a virtual machine for disaster recovery in a cloud computing environment according to embodiments of the present invention include IBM's zNM™, VMware's vCenter™, INTEGRITY™ from Green Hills Software, LynxSecure™ from LynuxWorks, IBM's POWER Hypervisor (PowerVM)™, Oracle's VM Server™, and Sun's Logical Domains Hypervisor™.

In the example of FIG. 2, the hypervisor (164) implements a VM (102) in the cloud computer (110). The VM (102) runs an application program (132) and an operating system (154). The VM (102) is a module of automated computing machinery, configured by the hypervisor, to allow the application (132) to share the underlying physical machine resources of cloud computer (110), the CPU (156), the RAM (168), the communications adapter (167) and so on. Each VM runs its own, separate operating system, and each operating system presents system resources to applications as though each application were running on a completely separate computer. That is, each VM is ‘virtual’ in the sense of being actually a complete computer in almost every respect. The only sense in which a VM is not a complete computer is that a VM typically makes available to an application or an operating system only a portion of the underlying hardware resources of a computer, particularly memory, CPU, and I/O resources. From the perspective of an application or an operating system running in a VM, a VM appears to be a complete computer.

Among other things, VMs enable multiple operating systems, even different kinds of operating systems, to co-exist on the same underlying computer hardware, in strong isolation from one another. The association of a particular application program with a particular VM eases the tasks of application provisioning, maintenance, high availability, and disaster recovery in data centers and in cloud computing environments. Because the operating systems are not required to be the same, it is possible to run Microsoft Windows™ in one VM and Linux™ in another VM on the same computer. Such an architecture can also run an older version of an operating system in one VM in order to support software that has not yet been ported to the latest version, while running the latest version of the same operating system in another VM on the same computer. Operating systems that are useful or that can be improved to be useful in deploying a virtual machine for disaster recovery in a cloud computing environment according to embodiments of the present invention include UNIX™, Linux™, Microsoft XP™, AIX™, and IBM's i5/OS™.

In the example of FIG. 2, the VM (102) is characterized by a Universally Unique Identifier (‘UUID’) (120). VMs in the example of FIG. 2 implement a distributing computing environment, and a UUID is an identifier of a standard administered by the Open Software Foundation that enable a distributed computing environment to uniquely identify components in the environment without significant central coordination. A UUID can uniquely identify a component such as a VM with confidence that the identifier, that is, the value of a particular UUID, will never be unintentionally used to identify anything else. Information describing components labeled with UUIDs can, for example, later be combined into a single database without needing to resolve name conflicts, because each UUID value uniquely identifies the component with which it is associated. Examples of UUID implementations that can be adapted for use in deploying a virtual machine for disaster recovery in a cloud computing environment according to embodiments of the present invention include Microsoft's Globally Unique Identifiers™ and Linux's ext2/ext3 file system.

The example apparatus of FIG. 2 includes a cloud operating system (194), a module of automated computing machinery installed and operating on one of the cloud computers (109). The cloud operating system (194) is in turn composed of several submodules: a virtual machine catalog (‘VMC’) (180), a deployment engine (‘DE’) (176), and a self service portal (‘SSP’) (172). The self service portal is so-called because it enables a user (101 on FIG. 1) to provide the user's own specification defining a VM, although a user specifying a VM through the self service portal typically has absolutely no knowledge whatsoever of the actual underlying computer hardware in the cloud computing environment—and no knowledge whatsoever regarding how the user's VM is disposed upon the underlying hardware. Any particular VM can be installed on a cloud computer with many other VMs, all completely isolated from one another in operation. And all such VMs, from the perspective of any operating system or application running on a VM, can have completely different configuration of computer resources, CPUs, memory, I/O resources, and so on.

In the example cloud operating system (194) of FIG. 2, the self service portal (172) exposes a user interface (170 on FIG. 1) for access by any user authorized to install VMs in the cloud computing environment (192). The self service portal (172) receives through its user interface user specifications of VMs. The user specifications include for each VM specifications of computer processors, random access memory, hard disk storage, input/output resources, application programs, disaster recovery requirements, and so on. The specifications can also include requirements for I/O response timing, memory bus speeds, Service Level Agreements (‘SLAs’), Quality Of Service (‘QOS’) requirements, and other VM specifications as may occur to those of skill in the art.

Having received user specifications for a VM, the cloud operating system (194) then deploys the now-specified VM in accordance with the received user specifications.

The self service portal (172) passes the user specification to the deployment engine (176). The self service portal retains any disaster recovery requirements supplied by the user in storage for use after deployment. The deployment engine selects from the VM catalog (180) a VM template that matches the user specifications. The deployment engine fills in the selected template with the user specifications and passes the complete template to the data center administration server (118), which calls a hypervisor on a cloud computer to install the VM specified by the selected, completed VM template. The data center administration server (118) records a network address (123) assigned to the new VM as well as a unique identifier for the new VM, here represented by a UUID (120), and returns the network address and the UUID to the deployment engine (176). The deployment engine (176) returns the network address and the UUID to the self service portal (172).

The subject VM (102) in this example has a disaster recovery requirement provided as part of its user specifications (174 on FIG. 1). Such a disaster recovery requirement is specified by a user through interface (170 on FIG. 1) and retained by the self service portal as part of the specification of a VM being installed in the cloud computer environment (192), thus ‘flagging’ the VM for disaster recovery in the records maintained by the self service portal. The term ‘disaster recovery’ is used here to refer to methods and apparatus that recover data processing services of VMs after a loss through disaster.

The self service portal (172) of the cloud operating system (194) stores in computer memory (116) in a remote data center (128), a copy (188) of the flagged VM (102). The self service portal (172) possesses data communications addresses, port numbers, and security permissions to enable it to store the copy in memory (116) in the remote data center (128). In apparatus like that of FIG. 2, a copy of a VM can be fully characterized, at any point in time during operation of the VM, by a completed template for the VM including user specifications and the contents of computer memory, including the contents of a CPU's architectural registers that are in use by the VM, the contents of RAM in use by the VM, and the contents of any hard disk space in use by the VM. In an embodiment, the computer memory (116) in the remote data center (128) is implemented as a Storage Area Network or ‘SAN’ whose memory is accessible remotely by the self service portal (172) in the form of Logical Unit Numbers or ‘LUNs.’ In some embodiments, the cloud operating system stores the copy not merely once but periodically with, for example, a periodicity specified by the user in the user specifications (174) for the VM (102). For a VM having no need for high availability, the cloud operating system may store the VM hourly or daily, for example, For others, the periodicity may be a small fraction of a second. In some embodiments, each store is a store of an entire copy of the VM. In others, the initial store is a full copy and periodic additional stores are incremental.

The self service module of the cloud operating system also configures the remote data center (128) to replace data processing operations of the flagged VM (102) in the local data center with data processing operations of the copy (188) in the remote data center when the flagged VM in the local data center is lost through disaster. Such configuring is carried out in an embodiment by advising the data center administration server (119) in the remote data center (128) of the need for disaster recovery service for the VM (102), of the fact that the copy (188) is now stored in computer memory (116) in the remote data center (128), and of the location in computer memory where the copy is stored, information which the data center administration server (119) in the remote data center (128) maintains in its computer memory. In some embodiments, the form of disaster recovery service actually provided by the remote data center can be a simple as returning the copy (188) to the local data center (127) as part of a disaster recovery plan for the local data center. In other embodiments, the cloud operating system (194, 172) configures the remote data center (128), that is, so advises the data center administration server (119) in the remote data center (128), to recover the copy (188) from computer memory (116) and deploy the copy as a VM (104) in the remote data center (128).

The application (132), the operating system (154), and the VM agent (122) in the example of FIG. 2 are illustrated for ease of explanation as disposed in RAM (168), but many components of such modules typically are stored in non-volatile memory also, such as, for example, on a disk drive or in Electrically Erasable Read Only Memory (‘EEPROM’) or ‘Flash’ memory. In addition, being modules of automated computing machinery, a module such as an application (132), an operating system (154), or a VM agent (122) can be implemented in various combinations of computer hardware and software, or entirely as computer hardware, a network of sequential and non-sequential logic including implementations as, for example, a Complex Programmable Logic Device (‘CPLD’), an Application Specific Integrated Circuit (‘ASIC’), or a Field Programmable Gate Array (‘FPGA’).

The arrangement of the server (118), the computers (109, 110, 114), and the network (100) making up the example apparatus illustrated in FIG. 2 are for explanation, not for limitation. Data processing systems useful for deploying a virtual machine for disaster recovery in a cloud computing environment according to various embodiments of the present invention may include additional servers, routers, other devices, and peer-to-peer architectures, not shown in FIG. 2, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 2.

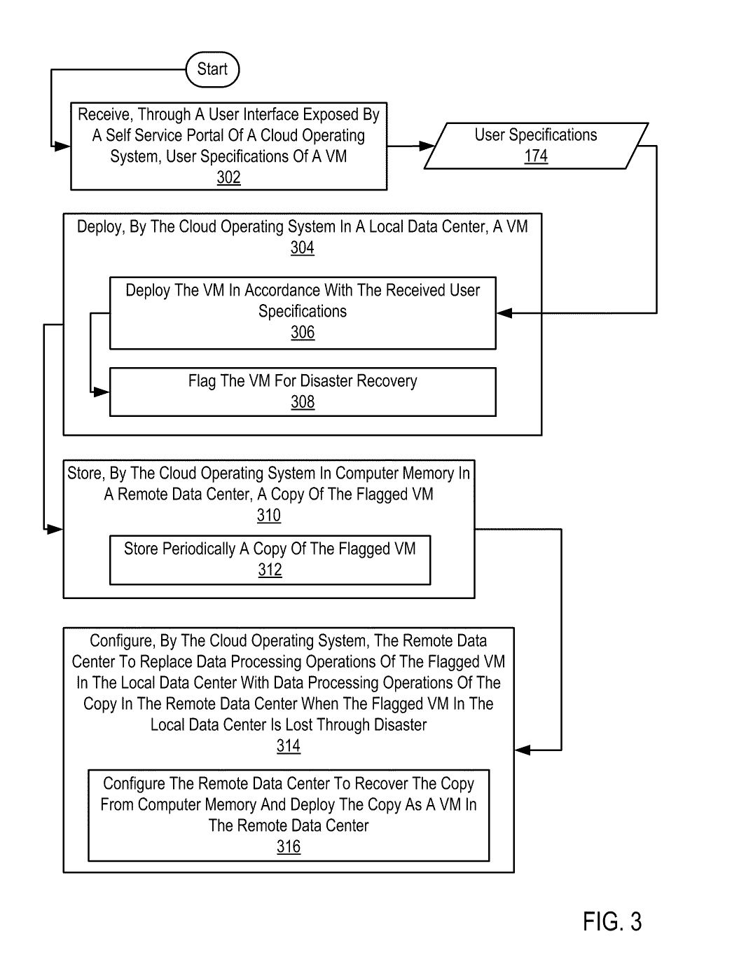

For further explanation, FIG. 3 sets forth a flowchart illustrating an example method of deploying a virtual machine for disaster recovery in a cloud computing environment according to embodiments of the present invention. The method of FIG. 3 is implemented in a cloud computing environment by and upon apparatus similar to that described above with reference to FIGS. 1 and 2, and the method of FIG. 3 is therefore described here with reference both to all three FIGS. 1, 2, and 3, using reference numbers from all three drawings. The method of FIG. 3 is carried out in a cloud computing environment (192) that includes VMs, with data center administration servers (118, 119) operably coupled to the VMs, operably coupled as in the examples of FIGS. 1 and 2 through a data communications network (100). The cloud computing environment (192) includes a cloud operating system (194) implemented as a module of automated computing machinery installed and operating on one of the cloud computers. The cloud operating system is in turn composed of several submodules: a virtual machine catalog (180), a deployment engine (176), and a self service portal (172). At least one VM (102) has a disaster recovery requirement for a copy to be stored remotely.

In the method of FIG. 3, operable coupling of the data center administration servers to the VMs includes, not only the network (100), but also VM managers (125, 126 on FIG. 2) implemented as modules of automated computing machinery on data center administration servers (118, 119) and a VM agent (122 on FIG. 2) that is also implemented as a module of automated computing machinery on VM (102). The VM Managers (125, 126) are shown here for convenience of explanation as two modules of automated computing machinery installed upon data center administration servers (118, 119), although as a practical matter, a data center can include multiple VM Managers, and VM Managers can be installed upon any data center computer or blade server having data communications connections to the VMs in the data center, including installation in a VM in a data center blade server, for example. Each VM manager (125, 126) implements administrative functions that communicate with VM agents on VMs to configure the VMs in a data center. The VM managers (125, 126) and the VM agent (122) are configured to carry out data communications through the network (100) between the data center administration servers (118, 119) and VMs on cloud computers.

The method of FIG. 3 includes receiving (302), through a user interface (170) exposed by a self service portal (172) of a cloud operating system (194), user specifications (174) of a VM, where the user specifications typically include specifications of computer processors, random access memory, hard disk storage, input/output resources, application programs, as well as requirements for disaster recovery. The method of FIG. 3 also includes deploying (304) the VM (102) in a local data center (127). In this example, deploying (304) the VM includes deploying (306) the VM in accordance with the received user specifications (174). In at least some embodiments, the deployment is carried out by a deployment engine (176) module of the cloud operating system (194). Deploying (304) the VM in this example also include flagging (308) the VM for disaster recovery, a step that in the embodiments described above, is carried out by the self service portal which retains in memory an identifier for the VM and information describing the disaster recovery requirement, which can be as simple as a one-bit Boolean indication that the VM requires disaster recovery services.

The method of FIG. 3 also includes storing (310), by the cloud operating system (194) in computer memory (116) in a remote data center (128), a copy (188) of the flagged VM (102). The remote data center is ‘remote’ in the sense that it is established in a location that is physically separate from the local data center where the VM flagged for disaster recovery is deployed. The self service portal (172) possesses data communications addresses, port numbers, security permissions, and the like, to enable it to store the copy in memory (116) in the remote data center (128). In apparatus that implements the method of FIG. 3, a copy of a VM can be fully characterized, at any point in time during operation of the VM, by a completed template for the VM including user specifications and the contents of computer memory, including the contents of a CPU's architectural registers that are in use by the VM, the contents of RAM in use by the VM, and the contents of any hard disk space in use by the VM. In an embodiment, the computer memory (116) in the remote data center (128) is implemented as a Storage Area Network or ‘SAN’ whose memory is accessible remotely by the self service portal (172) in the form of Logical Unit Numbers or ‘LUNs.’

In the method of FIG. 3, storing (310) a copy of the flagged VM includes storing (312) periodically a copy of the flagged VM. In this example, the cloud operating system (194) stores the copy not merely once but periodically with a periodicity specified by the user in the user specifications (174) for the VM (102). For a VM having no need for high availability, the cloud operating system may store the VM hourly or daily, for example. For others, the periodicity may be a small fraction of a second. In some embodiments, each store is a store of an entire copy of the VM. In others, the initial store is a full copy and periodic additional stores are incremental.

The method of FIG. 3 also includes configuring (314), by the cloud operating system (194), the remote data center (128) to replace data processing operations of the flagged VM (102) in the local data center (127) with data processing operations of the copy (188) in the remote data center (128) when the flagged VM in the local data center is lost through disaster. That is, the self service module of the cloud operating system also configures the remote data center (128) to replace data processing operations of the flagged VM (102) in the local data center with data processing operations of the copy (188) in the remote data center when the flagged VM in the local data center is lost through disaster. Such configuring is carried out in an embodiment by advising the data center administration server (119) in the remote data center (128) of the need for disaster recovery service for the VM (102), of the fact that the copy (188) is now stored in computer memory (116) in the remote data center (128), and of the location in computer memory where the copy is stored, information which the data center administration server (119) in the remote data center (128) maintains in its computer memory. In some embodiments, the form of disaster recovery service actually provided by the remote data center can be a simple as returning the copy (188) to the local data center (127) as part of a disaster recovery plan for the local data center. In other embodiments, the cloud operating system (194, 172) configures the remote data center (128), that is, so advises the data center administration server (119) in the remote data center (128), to recover the copy (188) from computer memory (116) and deploy the copy as a VM (104) in the remote data center (128). In the example of FIG. 3, configuring (314) the remote data center (128) includes configuring (316) the remote data center to recover the copy (188) from computer memory and deploy the copy as a VM (104) in the remote data center.

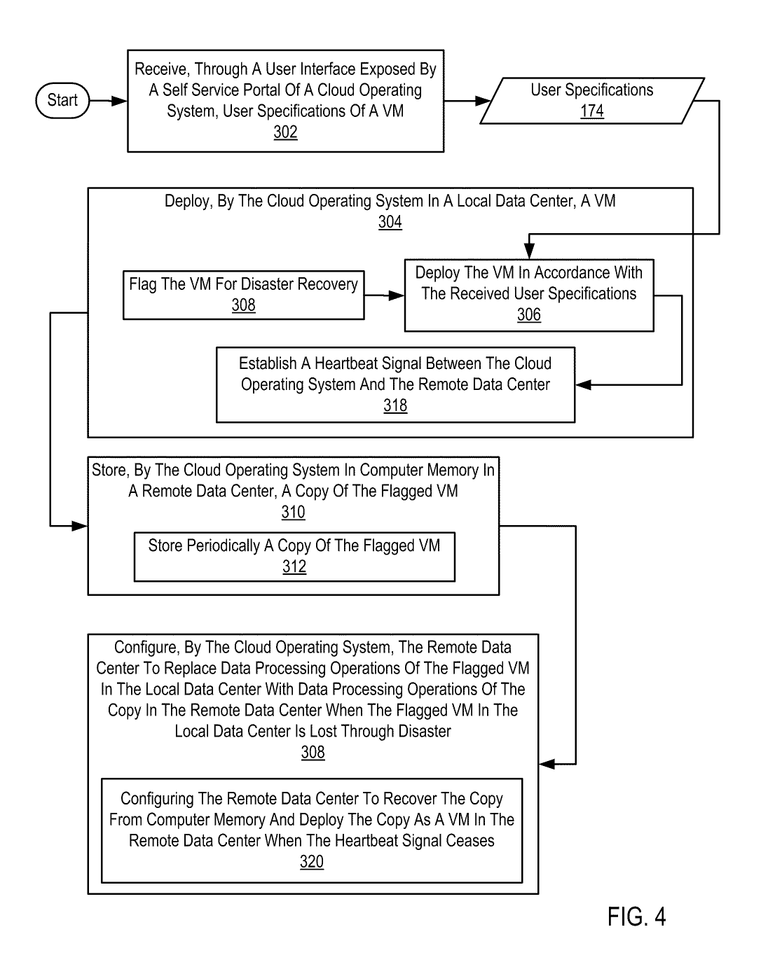

For further explanation, FIG. 4 sets forth a flowchart illustrating a further example method of deploying a virtual machine for disaster recovery in a cloud computing environment according to embodiments of the present invention. The method of FIG. 4 is implemented in a cloud computing environment (192) by and upon apparatus similar to that described above with reference to FIGS. 1 and 2, and the method of FIG. 4 is therefore described here with reference both to FIG. 4 and also to FIGS. 1 and 2, using reference numbers from all three drawings. The method of FIG. 4 is carried out in a cloud computing environment (192) that includes VMs, with data center administration servers (118, 119) operably coupled to the VMs, operably coupled as in the examples of FIGS. 1 and 2 through a data communications network (100). The cloud computing environment (192) includes a cloud operating system (194) implemented as a module of automated computing machinery installed and operating on one of the cloud computers. The cloud operating system is in turn composed of several submodules: a virtual machine catalog (180), a deployment engine (176), and a self service portal (172). At least one of the VMs (102) has a disaster recovery requirement for remote storage of a copy (188).

In the method of FIG. 4, operable coupling of the data center administration servers to the VMs includes, not only the network (100), but also VM managers (125, 126 on FIG. 2) implemented as modules of automated computing machinery on data center administration servers (118, 119) and a VM agent (122 on FIG. 2) that is also implemented as a module of automated computing machinery on VM (102). The VM Managers (125, 126) are shown here for convenience of explanation as two modules of automated computing machinery installed upon data center administration servers (118, 119), although as a practical matter, a data center can include multiple VM Managers, and VM Managers can be installed upon any data center computer or blade server having data communications connections to the VMs in the data center, including installation in a VM in a data center blade server, for example. Each VM manager (125, 126) implements administrative functions that communicate with VM agents on VMs to configure the VMs in a data center. The VM managers (125, 126) and the VM agent (122) are configured to carry out data communications through the network (100) between the data center administration servers (118, 119) and VMs on cloud computers.

The method of FIG. 4 is similar to the method of FIG. 3, including as it does receiving (302) user specifications of a VM, deploying (304) the VM, storing (310) a copy of the VM in a remote data center, and configuring (308) the remote data center to use the copy when the flagged VM is lost through disaster. In the method of FIG. 4, however, deploying (304) a VM also includes establishing (318) a heartbeat signal (138) between the cloud operating system (194) and the remote data center (128). As illustrated in FIG. 1, this example heartbeat signal (138) between the cloud operating system (194) and the remote data center (128) is established between the self service portal (172) module of the cloud operating system and a data center administration server (119) in the remote data center (128). The heartbeat signal (138) is a series of digital data messages, sent with a predetermined interval between messages, from the cloud operating system to the remote data center, indicating that the cloud operating system, and therefore the flagged VM, is alive and operating correctly. So long as the heartbeat signal is received regularly at the predetermined interval, the remote data center infers no loss of the flagged VM through disaster. If the predetermined interval lapses without a heartbeat signal, then the remote data center, that is, in this example, the data center administration server in the remote data center, determines that the cloud operating system and therefore the flagged VM in the local data center has been lost through disaster. Further in the method of FIG. 4, therefore, configuring (308) the remote data center includes configuring (320) the remote data center to recover the copy (188) from computer memory (116) and deploy the copy as a VM (104) in the remote data center when the heartbeat signal ceases.

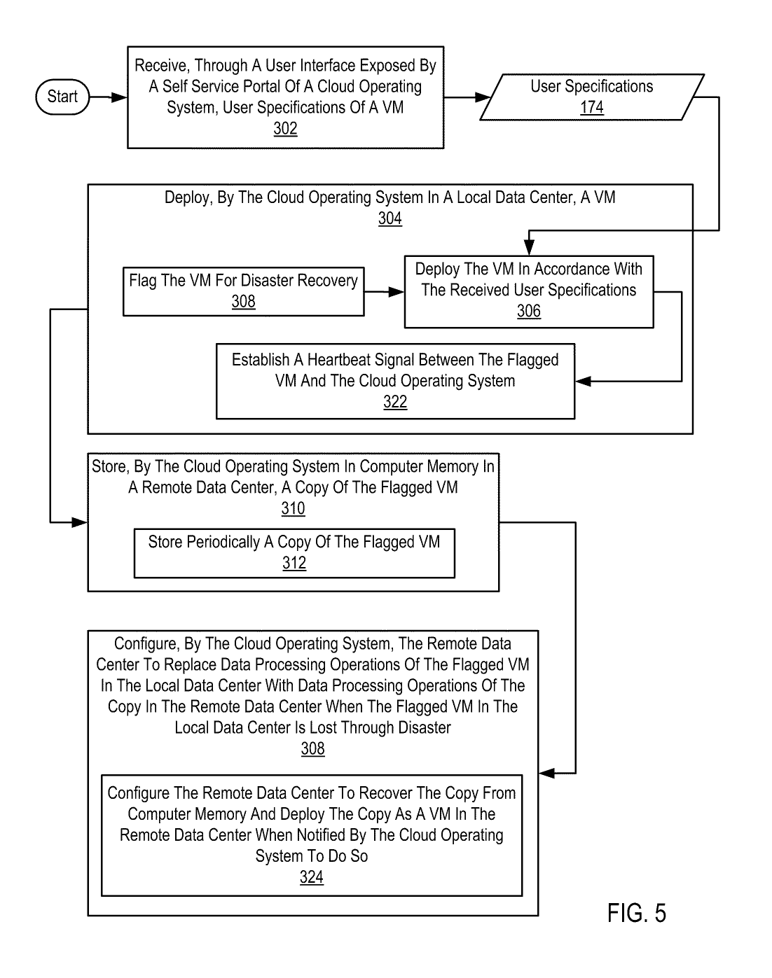

For further explanation, FIG. 5 sets forth a flowchart illustrating a further example method of deploying a virtual machine for disaster recovery in a cloud computing environment according to embodiments of the present invention. The method of FIG. 5 is implemented in a cloud computing environment (192) by and upon apparatus similar to that described above with reference to FIGS. 1 and 2, and the method of FIG. 5 is therefore described here with reference both to FIG. 5 and also to FIGS. 1 and 2, using reference numbers from all three drawings. The method of FIG. 5 is carried out in a cloud computing environment (192) that includes VMs, with data center administration servers (118, 119) operably coupled to the VMs, operably coupled as in the examples of FIGS. 1 and 2 through a data communications network (100). The cloud computing environment (192) includes a cloud operating system (194) implemented as a module of automated computing machinery installed and operating on one of the cloud computers. The cloud operating system is in turn composed of several submodules: a virtual machine catalog (180), a deployment engine (176), and a self service portal (172). At least one of the VMs (102) has a disaster recovery requirement for remote storage of a copy (188).

In the method of FIG. 5, operable coupling of the data center administration servers to the VMs includes, not only the network (100), but also VM managers (125, 126 on FIG. 2) implemented as modules of automated computing machinery on data center administration servers (118, 119) and a VM agent (122 on FIG. 2) that is also implemented as a module of automated computing machinery on VM (102). The VM Managers (125, 126) are shown here for convenience of explanation as two modules of automated computing machinery installed upon data center administration servers (118, 119), although as a practical matter, a data center can include multiple VM Managers, and VM Managers can be installed upon any data center computer or blade server having data communications connections to the VMs in the data center, including installation in a VM in a data center blade server, for example. Each VM manager (125, 126) implements administrative functions that communicate with VM agents on VMs to configure the VMs in a data center. The VM managers (125, 126) and the VM agent (122) are configured to carry out data communications through the network (100) between the data center administration servers (118, 119) and VMs on cloud computers.

The method of FIG. 5 is similar to the method of FIG. 3, including as it does receiving (302) user specifications of a VM, deploying (304) the VM, storing (310) a copy of the VM in a remote data center, and configuring (308) the remote data center to use the copy when the flagged VM is lost through disaster. In the method of FIG. 5, however, deploying (304) a VM also includes establishing (322) a heartbeat signal (134) between the flagged VM (102) and the cloud operating system (194). As illustrated in FIG. 1, this example heartbeat signal (134) between the flagged VM (102) and the cloud operating system (194) is established between the flagged VM (102) and the self service portal (172) module of the cloud operating system. The heartbeat signal (134) is a series of digital data messages, sent with a predetermined interval between messages, from the flagged VM (102) to the cloud operating system, indicating that the flagged VM (102) is alive and operating correctly. So long as the heartbeat signal is received regularly at the predetermined interval, the cloud operating system infers no loss of the flagged VM through disaster. If the predetermined interval lapses without a heartbeat signal, then the cloud operating system, that is, in this example, the self service portal (172) module of the cloud operating system, determines that the flagged VM (102) in the local data center has been lost through disaster and so notifies the remote data center, by a digital network message to the data center administration server (119) in the remote data center (128). Further in the method of FIG. 5, therefore, configuring (308) the remote data center includes configuring (324) the remote data center to recover the copy (199) from computer memory and deploy the copy as a VM (104) in the remote data center (128) when notified by the cloud operating system to do so.

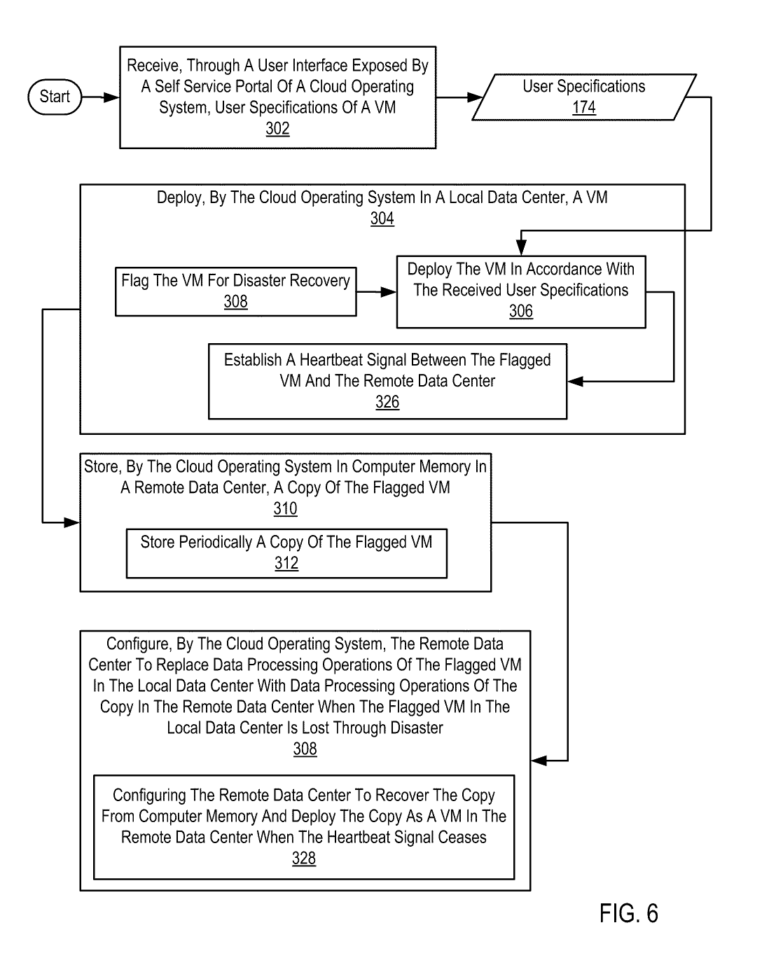

For further explanation, FIG. 6 sets forth a flowchart illustrating a further example method of deploying a virtual machine for disaster recovery in a cloud computing environment according to embodiments of the present invention. The method of FIG. 6 is implemented in a cloud computing environment (192) by and upon apparatus similar to that described above with reference to FIGS. 1 and 2, and the method of FIG. 6 is therefore described here with reference both to FIG. 6 and also to FIGS. 1 and 2, using reference numbers from all three drawings. The method of FIG. 6 is carried out in a cloud computing environment (192) that includes VMs, with data center administration servers (118, 119) operably coupled to the VMs, operably coupled as in the examples of FIGS. 1 and 2 through a data communications network (100). The cloud computing environment (192) includes a cloud operating system (194) implemented as a module of automated computing machinery installed and operating on one of the cloud computers. The cloud operating system is in turn composed of several submodules: a virtual machine catalog (180), a deployment engine (176), and a self service portal (172). At least one of the VMs (102) has a disaster recovery requirement for remote storage of a copy (188).

In the method of FIG. 6, operable coupling of the data center administration servers to the VMs includes, not only the network (100), but also VM managers (125, 126 on FIG. 2) implemented as modules of automated computing machinery on data center administration servers (118, 119) and a VM agent (122 on FIG. 2) that is also implemented as a module of automated computing machinery on VM (102). The VM Managers (125, 126) are shown here for convenience of explanation as two modules of automated computing machinery installed upon data center administration servers (118, 119), although as a practical matter, a data center can include multiple VM Managers, and VM Managers can be installed upon any data center computer or blade server having data communications connections to the VMs in the data center, including installation in a VM in a data center blade server, for example. Each VM manager (125, 126) implements administrative functions that communicate with VM agents on VMs to configure the VMs in a data center. The VM managers (125, 126) and the VM agent (122) are configured to carry out data communications through the network (100) between the data center administration servers (118, 119) and VMs on cloud computers.

The method of FIG. 6 is similar to the method of FIG. 3, including as it does receiving (302) user specifications of a VM, deploying (304) the VM, storing (310) a copy of the VM in a remote data center, and configuring (308) the remote data center to use the copy when the flagged VM is lost through disaster. In the method of FIG. 6, however, deploying (304) a VM also includes establishing (326) a heartbeat signal (136) between the flagged VM (102) and the remote data center (128). As illustrated in FIG. 1, this example heartbeat signal (136) between the flagged VM (102) and the remote data center (128) is established between the flagged VM (102) and a data center administration server (119) in the remote data center (128). The heartbeat signal (138) is a series of digital data messages, sent with a predetermined interval between messages, from the flagged VM (102) to the remote data center, indicating that the flagged VM is alive and operating correctly. So long as the heartbeat signal is received regularly at the predetermined interval, the remote data center infers no loss of the flagged VM through disaster. If the predetermined interval lapses without a heartbeat signal, then the remote data center, that is, in this example, the data center administration server in the remote data center, determines that the flagged VM (102) in the local data center has been lost through disaster. Further in the method of FIG. 6, therefore, configuring (308) the remote data center includes configuring (328) the remote data center to recover the copy (188) from computer memory (116) and deploy the copy as a VM (104) in the remote data center when the heartbeat signal ceases.

Example embodiments of the present invention are described largely in the context of a fully functional computer system for deploying a virtual machine for disaster recovery in a cloud computing environment. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, that is as apparatus, or as a method or a computer program product. Accordingly, aspects of the present invention may take the form of an entirely hardware embodiment, embodiments that are at least partly software (including firmware, resident software, micro-code, etc.), with embodiments combining software and hardware aspects that may generally be referred to herein as a “circuit,” “module,” “apparatus,” or “system.” Furthermore, aspects of the present invention may take the form of a computer program product embodied in one or more computer readable media having computer readable program code embodied thereon.

Any combination of one or more computer readable media may be utilized. A computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in a flowchart or block diagram may represent a module, segment, or portion of code or other automated computing machinery, which comprises one or more executable instructions or logic blocks for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of deploying a virtual machine in a cloud computing environment, the cloud computing environment comprising one or more virtual machines (‘VMs’), the VMs comprising modules of automated computing machinery installed upon cloud computers disposed within data centers, the cloud computing environment further comprising a cloud operating system and data center administration servers operably coupled to the VMs, the method comprising:
deploying, by the cloud operating system in a local data center, a VM, including flagging the VM for disaster recovery;
storing, by the cloud operating system in computer memory in a remote data center, a copy of the flagged VM; and
configuring, by the cloud operating system, the remote data center to replace data processing operations of the flagged VM in the local data center with data processing operations of the copy in the remote data center when the flagged VM in the local data center is lost through disaster.

2. The method of claim 1 wherein:
the cloud operating system comprises a module of automated computing machinery, further comprising a self service portal and a deployment engine;
the method further comprises receiving, through a user interface exposed by the self service portal, user specifications of the VM, the user specifications including specifications of computer processors, random access memory, hard disk storage, input/output resources, application programs, and a requirement for disaster recovery; and
deploying the VM further comprises deploying, by the deployment engine, the VM in accordance with the received user specifications.

3. The method of claim 1 wherein storing a copy of the flagged VM further comprises storing periodically a copy of the flagged VM.

4. The method of claim 1 wherein configuring the remote data center further comprises configuring the remote data center to recover the copy from computer memory and deploy the copy as a VM in the remote data center.

5. The method of claim 1 wherein:
deploying a VM further comprises establishing a heartbeat signal between the cloud operating system and the remote data center; and
configuring the remote data center further comprises configuring the remote data center to recover the copy from computer memory and deploy the copy as a VM in the remote data center when the heartbeat signal ceases.

6. The method of claim 1 wherein:
deploying a VM further comprises establishing a heartbeat signal between the flagged VM and the cloud operating system; and
configuring the remote data center further comprises configuring the remote data center to recover the copy from computer memory and deploy the copy as a VM in the remote data center when notified by the cloud operating system to do so.

7. The method of claim 1 wherein:
deploying a VM further comprises establishing a heartbeat signal between the flagged VM and the remote data center; and
configuring the remote data center further comprises configuring the remote data center to recover the copy from computer memory and deploy the copy as a VM in the remote data center when the heartbeat signal ceases.

8. Apparatus for deploying a virtual machine in a cloud computing environment, the apparatus comprising:
one or more virtual machines (‘VMs’), the VMs comprising modules of automated computing machinery installed upon cloud computers disposed within data centers; a cloud operating system; data center administration servers operably coupled to the VMs;
at least one computer processor with a computer memory operatively coupled to the at least one computer processor, the computer memory having disposed within it computer program instructions which when executed cause the apparatus to function by:
deploying, by the cloud operating system in a local data center, a VM, including flagging the VM for disaster recovery;
storing, by the cloud operating system in computer memory in a remote data center, a copy of the flagged VM; and
configuring, by the cloud operating system, the remote data center to replace data processing operations of the flagged VM in the local data center with data processing operations of the copy in the remote data center when the flagged VM in the local data center is lost through disaster.

9. The apparatus of claim 8 wherein:
the cloud operating system comprises a module of automated computing machinery, further comprising a self service portal and a deployment engine;
computer program instructions further cause the apparatus to function by receiving, through a user interface exposed by the self service portal, user specifications of the VM, the user specifications including specifications of computer processors, random access memory, hard disk storage, input/output resources, application programs, and a requirement for disaster recovery; and
deploying the VM further comprises deploying, by the deployment engine, the VM in accordance with the received user specifications.

10. The apparatus of claim 8 wherein storing a copy of the flagged VM further comprises storing periodically a copy of the flagged VM.

11. The apparatus of claim 8 wherein configuring the remote data center further comprises configuring the remote data center to recover the copy from computer memory and deploy the copy as a VM in the remote data center.

12. The apparatus of claim 8 wherein:
deploying a VM further comprises establishing a heartbeat signal between the cloud operating system and the remote data center; and
configuring the remote data center further comprises configuring the remote data center to recover the copy from computer memory and deploy the copy as a VM in the remote data center when the heartbeat signal ceases.

13. The apparatus of claim 8 wherein:
deploying a VM further comprises establishing a heartbeat signal between the flagged VM and the cloud operating system; and
configuring the remote data center further comprises configuring the remote data center to recover the copy from computer memory and deploy the copy as a VM in the remote data center when notified by the cloud operating system to do so.

14. The apparatus of claim 8 wherein:
deploying a VM further comprises establishing a heartbeat signal between the flagged VM and the remote data center; and
configuring the remote data center further comprises configuring the remote data center to recover the copy from computer memory and deploy the copy as a VM in the remote data center when the heartbeat signal ceases.

15. A computer program product for deploying a virtual machine in a cloud computing environment, the cloud computing environment comprising one or more virtual machines (VMs), the VMs comprising modules of automated computing machinery installed upon cloud computers disposed within data centers, the cloud computing environment further comprising a cloud operating system and data center administration servers operably coupled to the VMs, the computer program product disposed upon a computer readable storage medium, the computer program product comprising computer program instructions which when executed cause apparatus in the cloud computing environment to function by:
deploying, by the cloud operating system in a local data center, a VM, including flagging the VM for disaster recovery;
storing, by the cloud operating system in computer memory in a remote data center, a copy of the flagged VM; and
configuring, by the cloud operating system, the remote data center to replace data processing operations of the flagged VM in the local data center with data processing operations of the copy in the remote data center when the flagged VM in the local data center is lost through disaster.

16. The computer program product of claim 15 wherein:
the cloud operating system comprises a module of automated computing machinery, further comprising a self service portal and a deployment engine;
computer program instructions further cause apparatus in the cloud computing environment to function by receiving, through a user interface exposed by the self service portal, user specifications of the VM, the user specifications including specifications of computer processors, random access memory, hard disk storage, input/output resources, application programs, and a requirement for disaster recovery; and
deploying the VM further comprises deploying, by the deployment engine, the VM in accordance with the received user specifications.

17. The computer program product of claim 15 wherein configuring the remote data center further comprises configuring the remote data center to recover the copy from computer memory and deploy the copy as a VM in the remote data center.

18. The computer program product of claim 15 wherein:
deploying a VM further comprises establishing a heartbeat signal between the cloud operating system and the remote data center; and
configuring the remote data center further comprises configuring the remote data center to recover the copy from computer memory and deploy the copy as a VM in the remote data center when the heartbeat signal ceases.

19. The computer program product of claim 15 wherein:
deploying a VM further comprises establishing a heartbeat signal between the flagged VM and the cloud operating system; and
configuring the remote data center further comprises configuring the remote data center to recover the copy from computer memory and deploy the copy as a VM in the remote data center when notified by the cloud operating system to do so.

20. The computer program product of claim 15 wherein:
deploying a VM further comprises establishing a heartbeat signal between the flagged VM and the remote data center; and
configuring the remote data center further comprises configuring the remote data center to recover the copy from computer memory and deploy the copy as a VM in the remote data center when the heartbeat signal ceases.
